(19) United States
(12) Patent Application Publication
(10) Pub. No.: US 2017/0122404 A1
(43) Pub. Date: May 4, 2017

(54) FORCE TRANSMISSION BELT COMPRISING A POLYETHYLENE COATING

(71) Applicant: ARNTZ BETEILIGUNGS GMBH & CO. KG, Höxter (DE)

(72) Inventor: Daniel Pattie GIBSON, Höxter (DE)

(73) Assignee: ARNTZ BETEILGUNGS GMBH & CO. KG, Hoxter (DE)

(21) Appl. No.: 15/319,010

(22) PCT Filed: Jun. 17, 2015
(86) PCT No.: PCT/DE2015/000325

§ 371 Date: Dec. 15, 2016

(30) Foreign Application Priority Data
Jun. 17, 2014 (DE) 10 2014 008 622.4

(51) Int. Cl. F16G 1/16; F16G 5/14; C09D 123/06; F16G 1/28

(52) U.S. Cl. CPC F16G 1/16; F16G 1/28; F16G 5/14; C09D 123/06

(57) ABSTRACT

Disclosed is a force transmission belt comprising a belt member that has a base portion (11) and a force transmission zone (12) thereon, and comprising a polyethelene coating (18) on at least one surface of the belt member; in order to increase the service life, the polyethylene coating (18) is subjected to radiation at a dose of 30 to 300 kGy to increase the wear resistance of the coating.

The invention relates to a force transmission belt with, a belt structure comprising a belt body and comprising a force transmission zone, and also with a polyethylene coating on at least one surface of the belt structure.

These force transmission belts can be belts of any type, for example V-belts, V-ribbed belts, flat belts, and toothed belts, of any design. Force transmission belts are subject to wear in the force transmission zone, and the lifetime of a force transmission belt therefore often depends on the abrasion resistance of the surface of the force transmission zone. In the case of toothed belts in particular, however, considerable wear also takes place on the reverse side of the belt if there are retainers secured to the reverse side of the belt which are intended for transport and positioning of objects.

It is known that the force transmission zone surface that is subject to wear in a belt can be rendered more robust by providing, to the surface, a coating which is made of a plastic and which has friction-reducing and heat-reducing properties. U.S. Pat. No. 6,296,588 B1 discloses use, for this purpose, of a polyimide coating which has a significantly higher melting point than polyethylene.

WO 2013/091808 A1 discloses a force transmission belt of the type mentioned above. The structure envisaged in that document envisages a textile overlay on the surface subject to wear in a force transmission zone composed of polyurethane. The polyurethane here is generally cast in a mold onto the textile overlay. Polyurethane has an inherent property of tackiness, and the textile overlay surface representing the side that is subject to wear therefore has high coefficients of friction if during the cast-application process, liquid polyurethane penetrates through the textile and forms part of the surface of the textile overlay. It is therefore proposed that, before the cast-application of the polyurethane, a copolyamide that penetrates only to some extent into the textile layer is used for impregnation of that side of the textile layer that is subject to wear, with the result that on cast-application of the polyurethane this can also penetrate into the textile layer and bring about secure bonding, but without any possibility of emerging onto the opposite surface. In order to render the copolyamide impregnation layer impermeable throughout, a polyethylene coating in the form of a polyethylene film is applied, preferably by way of an adhesion-promoter layer. The function of the polyethylene film is provide a seal for the impregnation by the copolyamide, in particular for the procedure of cast-application of the polyurethane. The polyethylene coating can therefore be very thin, where the result is that it is rapidly removed or indeed, by virtue of the intervening layer, can be peeled away in the form of peelable film before the force transmission belt is brought into use. The polyethylene coating is preferably composed of HDPE, with properties advantageous for the use mentioned. These are in particular friction reduction, extensibility, and cohesion of the film.

Insofar as the polyethylene film is not peeled away before use, it is destroyed relatively rapidly during use, and relatively large-area fragments thereof separate from the belt. This impairs the usefulness of the force transmission belt and causes increased friction and heating.

The present invention is based on the object of providing improved durability to a force transmission. belt of the type mentioned above.

The invention achieves this object with a force transmission belt of the type mentioned above in that the polyethylene coating has been subjected to irradiation with a dose of from 30 to 300 kGy in order to increase its wear resistance.

The surface of the force transmission belt in the invention is protected by a polyethylene coating which, by virtue of irradiation on the one hand has been crosslinked to a greater extent and is therefore more robust, but on the other hand also comprises shorter molecular chains, with the result that values for elasticity and elongation are reduced. Surprisingly, the polyethylene coating thus treated can have significantly higher robustness than without irradiation. consequence of the resultant reduced elasticity and extensibility is that the polyethylene coating wears uniformly, i.e. does not separate in the form of relatively large coherent fragments from the belt. It has been found that use of the irradiated polyethylene coating, preferably in the form of an irradiated poly ethylene film, could increase the service time of the polyethylene coating to at least two to three times the original operating time. It is thus possible to use the polyethylene coating as a measure for increasing the service time of the force transmission belt.

The irradiation of the polyethylene coating is prefer ably achieved with gamma-radiation, and preferably with a dose of from 40 to 80 kGy. It is thus possible to achieve further crosslinking of the polyethylene in the coating, with a resultant increase in the robustness of the coating. Crosslinking of the polyethylene coating can also be achieved by using other ionizing radiation, for example beta-radiation, which is preferably used with a dose of from 200 to 300 kGy.

Insofar as the polyethylene coating is used in a multiple-ply coating structure as known from WO 2013/091808 A1, the polyethylene coating has two functions, in particular in belt structures made of polyurethane, because the polyethylene coating firstly promotes the impregnating effect of the copolyamide and does not allow polyurethane to reach the surface of the force transmission zone, and secondly fulfills a function for the surface of the force transmission zone, providing increased running time.

However, the inventive measure is not restricted to this specific use, but can also be realized without a textile ply and without a muitilayer structure of the coating: by way of example, it is possible to provide the polyethylene coating of the invention to the reverse side of a force transmission belt, optionally with the aid of an adhesive, and to use the properties of the irradiated polyethylene coating to increase the running time of the belt.

It is in principle known that the properties of polyethylene material can be changed by irradiation. This is true by way of example for implants made of polyethylene, although the irradiation causes loss of elongation, tensile strength, and notched impact resistance of said implants, while abrasion resistance is increased. However, it is novel and surprising that if a thin polyethylene coating on a force transmission belt has been treated by irradiation, in particular with gamma-radiation with an irradiation dose of from 40 to 80 kGy, said coating can be used to increase the service time of the force transmission belt.

It is preferable that the polyethylene coating is composed of HDPE. It can have been modified with a friction-reducing additive. Friction-reducing additives that can be used are PTFE, PVC, graphite, silicone, molybdenum disulfite, or the like. The polyethylene coatings can, of course, comprise the other conventional additives used for PE films.

The thickness of the polyethylene coating is preferably from 20 to 400 μm, with preference from 50 to 200 μm, in particular from 80 to 120 μm.

A conventional adhesion-promoter layer can be used for the application of the polyethylene coating, and can be a modified PE layer. The application can also be achieved with adhesives suitable for producing an adhesive bond between the material of the belt structure, for example, polyurethane, and the polyethylene coating or polyethylene film.

Since the polyethylene coating of the invention then has an increased lifetime on the surface of the force transmission belt, it is advantageous in some applications that the polyethylene coating takes the form of an antistatic surface. It is therefore advantageous that the polyethylene coating or polyethylene film is equipped with increased conductivity via conductive additives, for example carbon nanotubes or carbon black as additive, so that the surface has antistatic effect. Formation of an antistatic surface of a force transmission belt by means of a durable polyethylene coating or polyethylene film has independent significance and is not restricted to use of a polyethylene coating or film that has been rendered more durable by irradiation. This measure is always useful when the polyethylene coating or film remains in essence on the force transmission belt for the entire running time of the latter.

The invention will be explained in more detail below with reference to embodiments depicted diagrammatically in the drawing, where:

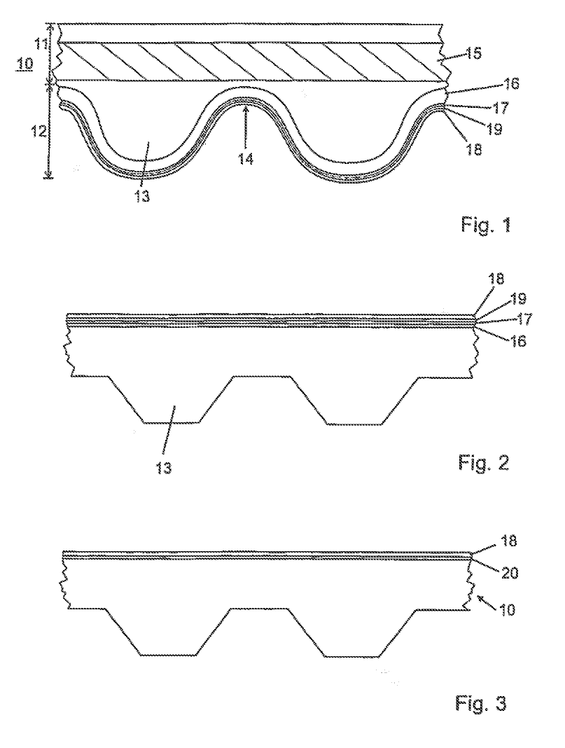

FIG. 1 is a longitudinal section through a toothed belt with a multilayer coating arrangement on the toothed side;

FIG. 2 is a longitudinal section through a toothed belt with a multilayer coating arrangement on the reverse side of the belt;

FIG. 3 is a longitudinal section through a toothed belt with a single-layer poly ethylene coating on the reverse side of the belt.

The force transmission belt depicted in FIG. 1 is a toothed belt 10 of which the belt structure comprises a belt body 11 and a force transmission zone 12. The force transmission zone 12 has teeth 13, between which teeth there are intervening spaces 14 present. Tension members 15, usually composed of metal wires arranged horizontally alongside one another, run within the belt body 11 in the longitudinal direction of the toothed belt 10.

In the embodiment depict 4 there is a textile layer 16 which covers the surface of the force transmission zone and which is intended to increase the abrasion resistance of the toothed belt 10 in the region of the force transmission one 12. For many applications, polyurethane is an advantageous material for the belt structure. In order to avoid permeation of the tacky polyurethane through the textile layer 16, the latter has a coating of an impregnation layer 17 made of copolyamide, where the copolyamide is applied in such a way that it penetrates to some extent into the textile layer. A polyethylene coating 18 made of HDPE covers the impregnation layer 17, and between the polyethylene coating 18 and the impregnation layer 17 here there is an intervening adhesion-promoter layer 18. The adhesion-promoter layer 19 can be composed of LLDPE and can have been modified in a known manner.

The thickness of the polyethylene coating 18 is about 100 μm, and said coating is preferably applied in the form of an HDPE film and heat-set. The polyethylene coating can, in particular, in the form of the film, have been irradiated with gamma-radiation prior to application, the radiation dose used here being from 40 to 80 kGy, in particular from 60 to 70 kGy, preferably 65 kGy. The polyethylene coating 18 has been modified h the irradiation, in that in particular long polymer chains have been cleaved and an additional crosslinking has taken place. Corresponding modification of the polyethylene coating can also be achieved by beta-radiation, where radiation doses used are preferably higher: up to 300 kGy.

In the embodiment depicted in FIG. 2, the layers 16, 17, 18, and 19 are present in the same sequence on the surface of the back of the belt, i.e. on the surface facing away from the teeth 13. This embodiment is suitable for withstanding high loading on the back of the belt.

The embodiments of FIGS. 1 and 2 can, of course, also be combined with one another, and the toothed belt 10 can therefore have the layer sequence 16 to 19 not only on the toothed side but also on the reverse side of the belt. It is moreover possible, of course, that corresponding layers are advantageously also provided to other forms of belt, for example V-belts and flat belts.

In the embodiment depicted in FIG. 3, the polyethylene coating 18 is likewise present on the reverse side of the belt, but has been applied there directly with the aid of a layer of an adhesive 20, without textile layer 16 and impregnation layer 17.

In all cases it is also possible that the irradiation of the polyethylene coating 18 takes place after the polyethylene coating 18 has been applied This has the advantage that the PE layer has good flow properties for the application of the polyethylene coating 18 and that the properties, including the flow properties, are not altered until the subsequent irradiation takes place.

### Loading Tests

The usage properties of the belts were tested in that continuous belts with a belt structure and cross sectional profile as shown in principle in FIG. 1 were exposed to high dynamic loading on a 2-pulley arrangement.

Each run was continued until discernible damage arose on the external polyethylene coating 18. Test rig parameters were kept constant for all of the experiments.

Test rig parameters:
2-Pulley system: continuous belt running over two pulleys of identical size;
Pulleys: type G profile in accordance with ISO 13050, each with 25 teeth, pitch 8 mm;
Velocity of pulleys: rotation rate 1000 min⁻¹;
Installed pretensioning: 600 N per side;
Torque 35 Nm;
Belt size: 112 teeth, width 12 mm, pitch 8 mm (8 M)
Cast PU belt with textile overlay and multilayer plastics coating (FIG. 1)

### 1. Comparative Experiments

A first series of tests was carried out on belts with an unirradiated HDPE coating 18. The fundamental structure of the coating on the textile overlay 16 was:
Impregnation layer 17—copolyamide (40 μm)
Adhesion-promoter layer 19—LLDPE (from 20 to 60 μm)
(on external side) PE coating 18—HDPE (from 30 to 100 μm)

In all of the experiments, while layer thicknesses are varied, there was no substantial difference in the maximal running time. In every case, at most 40 hours were required for the high test loading to abrade the edges of the force transmission zone 12 of the comparative belts with unirradiated HOPE coating. Toward the and of the maximal running time here, fragments of the PE coating 18 separated (flaked away) from the belt. The size of the HDPE fragments separated from the belt increased as the thickness of the coating 18 increased.

### 2. Loading Tests on Belts of the Invention

The same test rig and the same test conditions were used to test belts which differed from the comparative belts only in that the coating 18 had been irradiated, as stated in the description.

For these experiments, a coextruded multilayer film made from the films for the layers 17, 19, and 18 had been irradiated from the HOPE side i.e. on the surface of the coating 18 (for layers sequence see under comparative experiments). Production of the belts was otherwise identical with that of the comparative belts. In both cases the coating film composite was heat-set on the textile overlay 16, and a polyurethane belt was cast in a conventional manner against the back of the textile overlay 16.

Maximal running times achieved under the high test loading by the embodiments of the invention with irradiated coating 18 were from 100 to 150 hours, i.e. from two to three times as long as without irradiation of the external PE coating 18.

The abrasion resistance of the belt with irradiated exterior coating was therefore shown to have been significantly increased.

The invention is, of course, just as suitable for force transmission belts produced in continuous form as for force transmission belts produced with free ends.

Although in particular the present invention is particularly advantageous for force transmission belts with belt structures made of a thermoplastic, or a castable thermoset, polyurethane, it can also be used advantageously for force transmission belts with a belt structure made of any other familiar material.

1. A force transmission belt with a belt structure comprising:
a belt body,
a force transmission zone, and
a polyethylene coating on at least one surface of the belt structure,
wherein the polyethylene coating is composed of high density polyethylene (HDPE) and has been subjected to irradiation with a dose of from 30 to 300 kGy in order to increase its wear resistance.

2. The force transmission belt as claimed in claim 1, wherein the polyethylene coating is a layer in a multiple-ply coating structure, and wherein the layer of the polyethylene coating is exterior in relation to the cause of wear.

3. The force transmission belt as claimed in claim 1 wherein the belt structure has a textile overlayer, and the the polyethylene coating (18) is positioned on the textile overlayer.

4. The force transmission belt as claimed in claim 3, wherein the textile overlayer includes an impregnation layer made of a copolyamide.

5. (canceled)

6. The force transmission belt as claimed in claim 1 wherein the polyethylene coating is modified with a friction-reducing additive.

7. The force transmission belt as claimed in claim 1 wherein the polyethylene coating is applied as a film.

8. The force transmission belt as claimed in claim 7, further comprising an adhesion-promoter layer arranged between the film that forms the polyethylene coating and a surface supporting the polyethylene coating.

9. The force transmission belt as claimed in claim 8, wherein the adhesion-promoter layer is a modified polyethylene (PE) layer.

10. The force transmission belt as claimed in claim 1 wherein the polyethylene coating has a thickness ranging from 20 to 400 nm.

11. The force transmission belt as claimed in claim 1 wherein the polyethylene coating has been subjected to irradiation with gamma-radiation with a dose of from 30 to 80 kGy.

12. The force transmission belt as claimed in claim 1 wherein the polyethylene coating as been subjected to irradiation with beta radiation with a dose of from 150 to 300 kGy.

13. The force transmission belt as claimed in claim 1 wherein the polyethylene coating has been rendered antistatic via conductive additives.
